(19) United States
(12) Patent Application Publication
(10) Pub. No.: US 2006/0002355 A1
(43) Pub. Date: Jan. 5, 2006

(54) Method and system for providing handoff between mobile communication network and wireless local area network, and switching device therefor

(75) Inventors: Hye-Won Baek, Seongnam-si (KR); Sung-Won Lee, Seongnam-si (KR); Dong-Keon Kong, Suwon-si (KR); Sang-Jun Moon, Yongin-si (KR); Jong-Bum Pyo, Yongin-si (KR); Heung-Chul Jung, Suwon-si (KR); Eun-Young Chung, Suwon-si (KR); Sang-Do Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/173,158

(22) Filed: Jul. 5, 2005

(30) Foreign Application Priority Data
Jul. 5, 2004 (KR) 2004-52125

(51) Int. Cl. H04Q 7/24

(52) U.S. Cl. 370/338

(57) ABSTRACT

A method and system for providing a handoff between a mobile communication network including a mobile switching center (MSC) and a home location register (HLR), and a wireless local area network (WLAN) including an access point (AP) and a voice over Internet protocol (VoIP) gateway to provide a VoIP service. The HLR registers therein subscriber information for the MT including an Internet protocol (IP) address of the AP. The MT transmits a handoff request to the MSC if the MT connected to the mobile communication network has moved to a region of the WLAN. The HLR transmits the subscriber information to the VoIP gateway. The AP allocates an IP address and a channel for WLAN access by the MT, and sets a session for a VoIP service of the MT.

### PRIORITY

This application claims the benefit under 35 U.S.C. §119(a) of an application entitled “Method and System for Providing Handoff between Mobile Communication Network and Wireless Local Area Network, and Switching Device Therefor” filed in the Korean Intellectual Property Office on Jul. 5, 2004 and assigned Serial No. 2004-52125, the entire contents of which are hereby incorporated by reference.

### BACKGROUND OF THE INVENTION

1. Field of the Invention

The present invention generally relates to a method and system for providing inter-network handoffs. In particular, the present invention relates to a method and system for providing a handoff between a mobile communication network supporting a circuit-switched voice service and a wireless local area network (WLAN) supporting a voice over Internet protocol (VoIP)-based voice service, and a switching device therefor.

2. Description of the Related Art

Generally, mobile communication networks supporting circuit-switched voice service are classified according to their communication methods. The mobile communication networks are classified into one of either a Frequency Division Multiple Access (FDMA) mobile communication network in which a full frequency band is divided into a plurality of frequency channels and then uniquely allocated to a plurality of subscribers, a Time Division Multiple Access (CDMA) mobile communication network in which one frequency channel is time-shared by a plurality of subscribers, or a Code Division Multiple Access (TDMA) mobile communication network in which codes are uniquely allocated to the subscribers that use the same frequency band in the same time band.

With the rapid progress of communication technology, the latest mobile communication networks provide not only the existing voice service but also high-speed data service in which a user with a mobile terminal can enjoy multimedia services including E-mail, still image and moving image services. Also, it is well known that a 3^{rd} generation (3G) mobile communication system supporting both the voice service and the packet service includes a synchronous CDMA 2000 1x system, a 1x Evolution Data Only (EV-DO) system capable of high-speed packet transmission, an Evolution of Data and Voice (EV-DV) system, and an asynchronous Universal Mobile Telecommunication Systems (UMTS) system.

In the conventional data transmission method, the voice service is provided through a circuit-switched network such as a public switched telephone network (PSTN) and the packet service is provided through an Internet/Public Serving Data Network (PSDN), which is an Internet protocol (IP) network. However, the well-known VoIP technology has been proposed to provide the voice service even through the IP network. With the development of the IP network, the VoIP can enable a high-quality voice call by overcoming the 56-Kbps voice bandwidth limit of the circuit-switched network and also enable inexpensive international calls for only the associated Internet service provider fee. In addition, the VoIP can provide various application solutions and additional services. Due to the advantages, the number of VoIP users is increasing rapidly.

While the conventional VoIP service was provided through a personal computer (PC) or a wire network, the VoIP service can be provided even through a wireless local area network (WLAN). Therefore, subscribers can receive the VoIP service even through a mobile terminal such as a cellular phone.

FIG. 1 is a block diagram illustrating a simple configuration of a mobile communication network supporting the conventional VoIP service. In FIG. 1, a mobile terminal (MT) 110 is a dual-mode terminal that can access both a circuit-switched network and a packet network, and can also access a WLAN via an access point (AP) 120.

The MT 110 performs Pulse Code Modulation (PCM) on an analog voice signal of its user, compresses the PCM-modulated signal, converts the compressed signal into a voice packet appropriate for a WLAN standard, and transmits the voice packet to the AP 120. The AP 120 delivers the received voice packet to a VoIP gateway 130 via an IP network 1. The VoIP gateway 130, intervening between the IP network 1 and a PSTN 2, transmits and receives various control signals for transmission of voice signals, and performs data conversion. In other words, the VoIP gateway 130 converts the voice packet received from the AP 120 into a voice signal appropriate for the PSTN 2, and transmits the voice signal to the PSTN 2. Further, the VoIP gateway 130 inversely converts a voice signal of the other party, received from the PSTN 2, into a voice packet, and delivers the voice packet appropriate for a WLAN standard to the MT 110 via the AP 120.

With the use of the dual-mode MT 110, the user can receive the voice service through both the general cellular mobile communication network and the WLAN, which is a packet network. As for the mobility of the MT 110, a handoff in the mobile communication network and the WLAN is possible, but inter-network handoff between the mobile communication network and the WLAN has not been taken into consideration. It is expected that the need for the inter-network handoff between the mobile communication network and the WLAN will dramatically increase as a WLAN environment will become more commonly provided in homes and offices. In particular, there is a demand for seamless handoff taking into account a time delay occurring during handoff of the voice service to the WLAN environment.

### SUMMARY OF THE INVENTION

It is, therefore, an object of the present invention to provide a method and system for providing a handoff between a mobile communication network supporting a circuit-switched voice service and a wireless local area network (WLAN) supporting a voice over Internet protocol (VoIP)-based voice service.

It is another object of the present invention to provide a handoff method and system for reducing power consumption of a mobile terminal by simplifying a handoff process from a mobile communication network to a WLAN.

It is further another object of the present invention to provide a switching device for providing a handoff between a mobile communication network supporting a circuit-switched voice service and a WLAN supporting a VoIP-based voice service.

According to one aspect of the present invention, there is provided a method for providing handoff between a mobile communication network comprising a mobile switching center (MSC) for controlling call processing such that a circuit-switched voice service is provided to a mobile terminal (MT), and a home location register (HLR) in which subscriber information is registered, and a wireless local area network (WLAN) comprising an access point (AP) and a voice over Internet protocol (VoIP) gateway to provide a VoIP service. The method comprises the steps of registering, by the AP, subscriber information for the MT comprising an Internet protocol (IP) address of the AP, in the HLR; transmitting, by the MT, a handoff request to the MSC if the MT connected to the mobile communication network has moved to a region of the WLAN; transmitting, by the HLR, the subscriber information to the VoIP gateway; allocating an IP address and a WLAN channel to the MT; and setting a session for a VoIP service of the MT.

According to another aspect of the present invention, there is provided a system for providing a handoff between a mobile communication network supporting a circuit-switched voice service to a mobile terminal (MT) and a wireless local area network (WLAN) supporting a voice over Internet protocol (VoIP)-based voice service. The system comprises an access point (AP) for allocating an Internet protocol (IP) address and a wireless channel used by the MT if the MT desires to access the WLAN; a home location register (HLR) for registering therein predetermined subscriber information for the MT including an IP address of the AP; a mobile switching center (MSC) for forwarding a handoff request message to the WLAN upon receiving the handoff request message from the MT; and a switching device for, upon receiving the handoff request message from the MT, receiving the subscriber information from the HLR, performing a predetermined authentication process using the subscriber information, and performing session connection for WLAN access by the MT.

According to another further aspect of the present invention, there is provided a switching device included in a wireless location area network (WLAN) that provides a voice over Internet protocol (VoIP) service to at least one mobile terminal (MT). The switching device comprises a wireless soft switch (WSS) for registering subscriber information for the MT including Internet protocol (IP) information of an access point (AP) for WLAN access by the MT in a home location register (HLR) of a mobile communication network, and upon receiving a handoff request of the MT from a mobile switching center (MSC) of the mobile communication network, performing session connection for the MT using the subscriber information; and a media gateway (MGW) connected to the WSS through a gateway control protocol, for performing data conversion between the mobile communication network and the WLAN.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a brief configuration of a mobile communication network supporting the conventional VoIP service;

FIG. 2 is a block diagram illustrating a network configuration of a handoff system between a mobile communication network and a wireless local area network (WLAN) according to an embodiment of the present invention;

FIGS. 3A and 3B are flowcharts for a description of a handoff method between a mobile communication network and a WLAN according to an embodiment of the present invention; and

FIG. 4 is a block diagram illustrating a structure of a switching device for handoff between a mobile communication network and a WLAN according to an embodiment of the present invention.

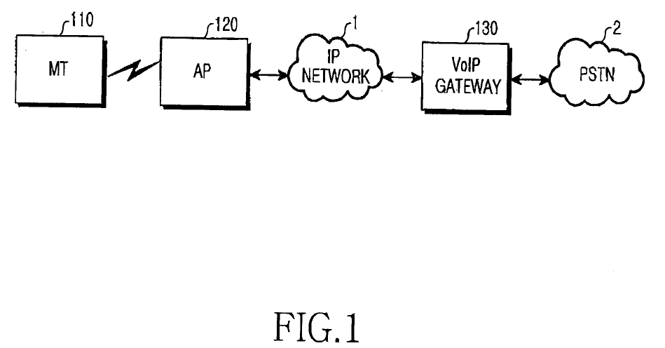

Throughout the drawings it should be understood that like reference numerals refer to like features, structures and elements.

### DETAILED DESCRIPTION OF EXEMPLARY EMBODIMENTS

Several exemplary embodiments of the present invention will now be described in detail with reference to the annexed drawings. In the following description, a detailed description of known functions and configurations incorporated herein has been omitted for the sake of conciseness.

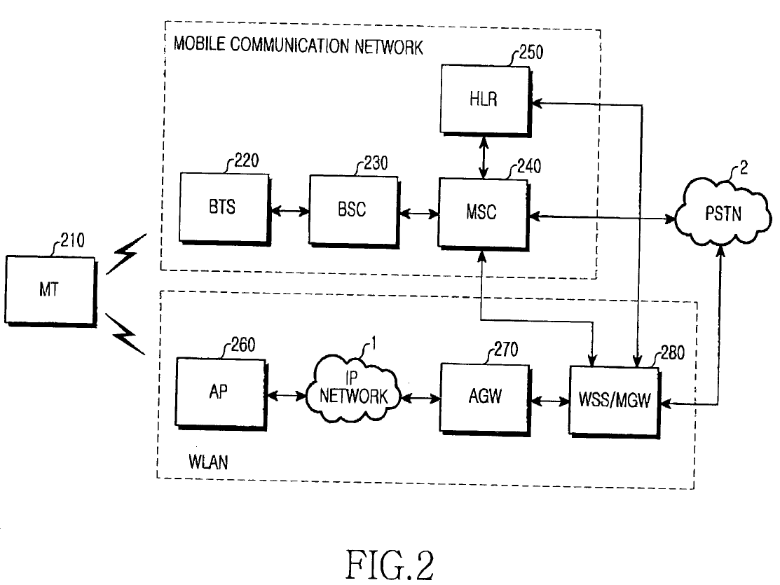

FIG. 2 is a block diagram illustrating a network configuration of a handoff system between a mobile communication network and a wireless local area network (WLAN) according to an embodiment of the present invention. The handoff system comprises a dual-mode mobile terminal (MT) 210 supporting access to both the mobile communication network, which is a cellular network, and the WLAN, the mobile communication network, connected to the MT 210 via a wireless network, for providing a circuit-switched voice service. The WLAN is connected to the MT 210 via the wireless network and located in a cell of the mobile communication network, for providing not only IP network access service but also the VoIP service.

The embodiments of the present invention will be described on the following assumption. The MT 210 is a dual-mode terminal, capable of communicating in an indoor region, where a WLAN service is provided, and in an outdoor region where a cellular voice service is provided via a mobile communication network. In a home location register (HLR) 250 of the mobile communication network, a vocoder type used in the indoor region upon service initiation of the MT 210 should be previously defined. In an access gateway (AGW) 270, an IP address of a wireless soft switch (WSS) 280 that supports a mobile identification number (MIN) of the MT 210 and serves as a signaling gateway for a VoIP service of the MT 210 should be previously specified.

A detailed description will now be made of the network elements provided to perform seamless handoff between a mobile communication network and a WLAN in the system of FIG. 2.

The MT 210, when it accesses the mobile communication network, operates according to a CDMA 2000 1x standard or a UMTS scheme. The MT 210 operates according to an IEEE 802.1x scheme, when it accesses the WLAN. The MT 210 accesses a mobile switching center (MSC) 240 via a base transceiver system (BTS) 220 and a base station controller (BSC) 230, which constitute a wireless access network of the mobile communication network.

The MSC 240, connected to a public switched telephone network (PSTN) 2, downloads, from the HLR 250, information on a subscriber that receives not only a circuit-switched voice service but also a VoIP service during handoff from the mobile communication network to the WLAN, and registers the downloaded information in an undepicted visitor location register (VLR). The MSC 240 performs call processing (call termination or origination) and call setup for the subscriber depending on the current location information of the MT 210, and thereafter, relays a voice traffic transmission. In the MSC 240, preferably, a Signaling System 7 (SS7) point should be previously specified.

In order to provide a VoIP service during handoff of the MT 210, the information on a subscriber registered in the HLR 250 preferably includes an IP address of an access point (AP) 260 to which the MT 210 is connected in a WLAN region and information on a vocoder type used by the MT 210 in the corresponding WLAN region. The HLR 250 performs extensible authentication protocol (EAP) authentication with the AP 260 such that subscriber authentication through an undepicted authentication, authorization and accounting (AAA) server (or authentication server) is achieved when the MT 210 performs handoff to the WLAN.

Herein, during the initial booting of the AP 260, the HLR 250 previously registers and stores an IP address of the AP 260, which was previously delivered from the AP 260 via the WSS.

The MT 210, when performing handoff to the WLAN, accesses an IP network 1 via the AP 260 and performs packet communication such as the VoIP service. It is assumed herein that the AP 260 includes an undepicted access point controller (APC) for controlling packet communication.

The MT 210 includes an IP multimedia subsystem (IMS) session initiation protocol (SIP) client that receives an SIP Invite message (or call setup request message) delivered from the WSS, which performs a session connection for the VoIP service, and transmits a 200 OK message (or response message) to the WSS in response to the SIP Invite message.

The SIP refers to a session initiation protocol used in an IMS that accesses a core network of another communication network such as the mobile communication network or the PSTN 2 via a gateway and provides an IP-based communication service to subscribers.

Herein, the AGW 270 for delivering an IP address of the AP 260 to an WSS, the WSS for receiving the subscriber information from the HLR 250 of the mobile communication network during handoff of the MT 210 and transmitting predetermined pre-authentication information for previously performing subscriber authentication on the MT 210 to the AP 260, and a media gateway (MGW) for performing data conversion between the mobile communication network or the PSTN 2 and the IP network 1, constitute an IMS domain.

The pre-authentication information includes a medium access control (MAC) address, an international mobile subscriber identity (IMSI), a MIN and a subscriber identity module (SIM) of the MT 210 in the case of an UMTS terminal, and includes a MAC address, an IMSI and a MIN of the MT 210, and a network access identifier (NAI) representing an address of the MT 210 in the form of an Internet domain in the case of a CDMA terminal.

A WSS/MGW 280 includes the WSS serving as a signaling gateway for a VoIP service and the MGW serving as a media gateway for data conversion between a voice signal of the mobile communication network and a voice packet of the WLAN. The AGW 270 and the WSS/MGW 280 form a VoIP gateway supporting a handoff service between the mobile communication network and the WLAN.

In this configuration, the MT 210 moving from the mobile communication network to the WLAN sends a handoff request to the MSC 240, while maintaining the connection to the mobile communication network, and the MSC 240 forwards the handoff request from the MT 210 to the WSS/MGW 280 belonging to the IMS domain. The WSS/MGW 280, receiving the handoff request from the MT 210, receives subscriber information including an IP address of the AP 260 accessed by the handoff requesting MT 210 and vocoder type information, from the HLR 250 of the mobile communication network.

The WSS/MGW 280 sets up an IP tunnel to the AP 260 and delivers pre-authentication information for the MT 210 to the AP 260 through the IP tunnel, and the AP 260 performs EAP authentication with the HLR 250 through an undepicted AAA server using the pre-authentication information. Thereafter, the AP 260 allocates an IP address for an access to the WLAN by the MT 210, and delivers channel information available for the MT 210 to the WSS/MGW 280.

In addition, the WSS/MGW 280 delivers the received channel information to the MSC 240, and the MSC 240 delivers channel information available in the WLAN to the MT 210 connected to the mobile communication network. The MT 210, after receiving the channel information, sets up a session connection to the WSS/MGW 280 and performs a seamless handoff from the mobile communication network to the WLAN.

That is, at the handoff request of the MT 210, according to embodiments of the novel method the steps of previously transmitting the pre-authentication information to the AP 260 to reduce any authentication delay occurring during the IP allocation and the channel allocation for the MT 210, transmits the channel information available in the WLAN to the MT 210 connected to the mobile communication network via the MSC 240, performing an IP allocation to the MT 210, and thereafter, performing an association (or connection setup) between the MT 210 and the AP 260, thereby reducing the time required for handoff are performed. In this manner, embodiments of the novel method reduce the power consumption of the MT that must maintain the connection of both a channel to the mobile communication network and a channel to the WLAN until an end of the handoff process, and also provide seamless service to the user during the handoff from the mobile communication network to the WLAN.

Embodiments of the present invention can implement a selected one of an operation of decreasing an authentication delay by transmitting the pre-authentication information and an operation of decreasing an access time to the WLAN by previously transmitting channel information.

A detailed description will now be made of the WSS/MGW 280, which is a switching device serving as a signaling gateway for a VoIP service of the MT 210 that performs handoff from the mobile communication network to the WLAN.

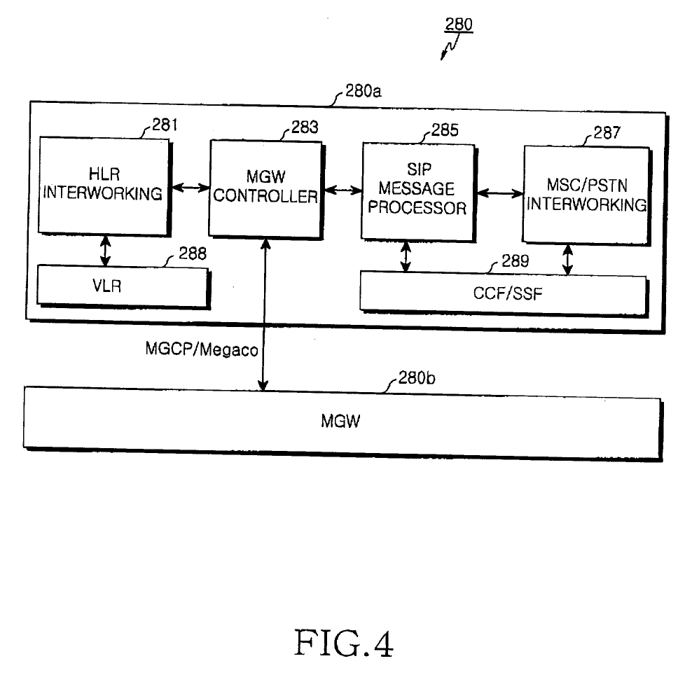

FIG. 4 is a block diagram illustrating a structure of a switching device for performing a handoff between a mobile communication network and a WLAN according to an embodiment of the present invention.

In FIG. 4, a WSS 280a registers subscriber information for access to the WLAN by the MT 210, such as IP information of the AP 260 in the HLR 250, and sends a request for a session connection to the MT 210 to the AP 260 using an SIP message. The WSS 280a is designed such that it delivers pre-authentication information of the MT 210 handing off to the AP 260 and previously delivers channel information of the WLAN to which the MT 210 is connected to the MSC 240. The MSC 240 reduces a WLAN access time of the MT 210 by transmitting a handoff command message including channel information to the MT 210.

An MGW 280b is preferably connected to the WSS 280a via a media gateway control protocol (MGCP)/MEGACO, which is a gateway control protocol, and performs data conversion between the mobile communication network and the WLAN. In particular, the MGW 280b is designed such that it supports transcoding between various codecs (G.711, G.729, G.723, and the like) for voice traffic, and various transmission layers (IP, ATM, and TDM).

The WSS 280a comprises an HLR interworking block 281 for registering subscriber information of the MT 210 in the HLR 250, an MGW controller 283 for handling connection and or release of a bearer by controlling the MGW 280b, and an SIP message processor 285 for processing an SIP message for call connection and or release of the MT 210. Further, the WSS 280a comprises an MSC/PSTN interworking block 287, a visitor location register (VLR) 288, and a call control function (CCF)/service switching function (SSF) 289 for processing a call state of a subscriber and an additional service.

The HLR interworking block 281 receives, from the point to point protocol (PPP)-connected AP 260, not only an IP address of the corresponding AP 260 but also an IP address registration message including IMSIs and/or MINs of the MTs 210 served by the AP 260 in a WLAN region, and delivers the received IP addresses to the HLR 250. The HLR interworking block 281 can use an interim standard (IS)-41 MAP as a signaling protocol for interworking with the HLR 250. If a call connection and or release signal is received from the SIP message processor 285 or the MSC/PSTN interworking block 287, the MGW controller 283 exchanges a control signal for a bearer connection and or release with the MGW 280b.

The SIP message processor 285 processes call connection and or releases for the VoIP service or processes SIP messages used for providing various additional services. Herein, in the process of performing a session connection for the MT 210, the SIP message processor 285 transmits an SIP Invite message to the MT 210 via the AP 260 and receives a 200 OK message from the MT 210 in response to the SIP Invite message.

The MSC/PSTN interworking block 287 receives a handoff request message of the MT 210 from the MSC 240, and delivers available channel information for the MT 210 received from the AP 260 to the MSC 240. The MSC/PSTN interworking block 287 controls a call connection service to the MSC 240 or an undepicted PSTN according to a location of a called terminal, and the VLR 288 stores a subscriber profile delivered from the HLR 250, if a location of the MT 210 is registered therein. The CCF/SSF 289 delivers pre-authentication information for the MT 210 to the AP 260, manages the call states of subscribers and controls various additional services, and interworks with the MSC/PSTN interworking block 287 and the SIP message processor 285.

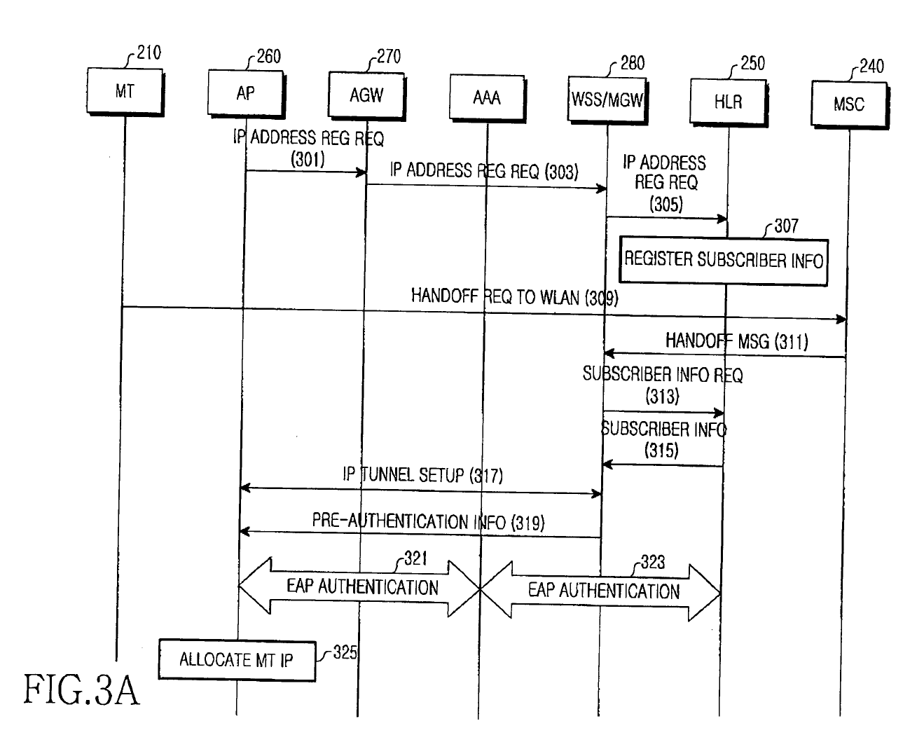

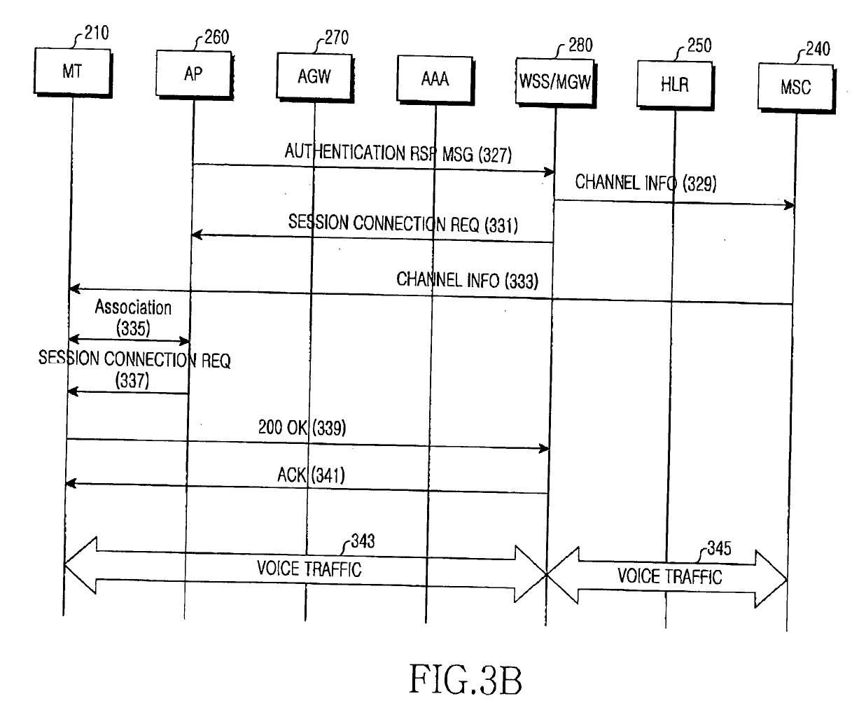

FIGS. 3A and 3B are flowcharts for a handoff method between a mobile communication network and a WLAN according to an embodiment of the present invention. A detailed description of the proposed handoff method will be made herein below with reference to FIGS. 2, 3A and 3B.

If an xDSL modem (not shown) used by an AP 260 is booted up, the AP 260 and an AGW 270 set a point-to-point protocol (PPP) therebetween. After the PPP setup, the AP 260 transmits its IP address registration message to the AGW 270 in step 301. Herein, the AP 260 previously stores IMSIs and MINs of its MTs, and transmits the IMSIs and MINs of the MTs using the IP address registration message.

In step 303, an AGW 270, upon receiving the IP address registration message from the AP 260, forwards the IP address registration message of the corresponding AP 260 to a WSS/MGW 280 that manages the IMSIs and MINs of a plurality of MTs, included in the registration message. In step 305, the WSS/MGW 280 forwards the received IP address registration message to an HLR 250. Although the IP address of the AP 260 is allocated herein through PPP setup between the AP 260 and the AGW 270, the PPP setup process can be omitted by allocating a fixed IP to the AP 260.

In step 307, the HLR 250 receives the IP address registration message of the AP 260, transmitted from the WSS/MGW 280, and registers and stores an IP address of the corresponding AP 260 as subscriber information along with vocoder type information upon service initiation of the MT 210. In step 309, if there is an MT 210 that has entered a WLAN region from a mobile communication network region, the MT 210 transmits a handoff request message including its MAC address, MIN, SIM and NAI to the MSC 240.

In step 311, the MSC 240 transmits a handoff message including a MAC address, a MIN and an IMSI of the handoff requesting MT 210 to the WSS/MGW 280. For example, a facilities directive (FACDIR) message used during hard handoff of the MSC 240 can be used as the handoff message transmitted in step 311 to the WSS/MGW 280. Upon receiving the handoff message, the WSS/MGW 280 performs a MAP operation using the MIN to acquire subscriber information from the HLR 250.

In step 313, the WSS/MGW 280 transmits to the HLR 250 a request for transmission of subscriber information of the handoff requesting MT 210. In step 315, the HLR 250 transmits subscriber information including an IP address of the corresponding AP 260 and a vocoder type of the MT 210 to the WSS/MGW 280, and the WSS/MGW 280 stores the received subscriber information and then performs service control on a VoIP call. In step 317, the WSS/MGW 280 receiving the subscriber information sets an IP tunnel to the AP 260 to which the MT 210 belongs, to previously perform WLAN access authentication for the MT 210. In step 319, the WSS/MGW 280 transmits pre-authentication information for WLAN access authentication for the MT 210 to the corresponding AP 260.

The pre-authentication information preferably comprises a MAC address, an IMSI, a MIN and a SIM of the MT 210 in the case of an UMTS terminal, and comprises a MAC address, an IMSI, a MIN, and NAI of the MT 210 in the case of a CDMA terminal. In this manner, embodiments of the present invention can reduce the authentication time required in the process of accessing the WLAN by the MT 210 by transmitting pre-authentication information to the AP 250 before the IP allocation and channel allocation for the MT 210.

In steps 321 and 323, the AP 260 performs EAP authentication for WLAN access by the HLR 250 and the MT 210 via an AAA server. After the successful EAP authentication, the AP 260 allocates an IP address to the corresponding MT 210 in step 325. In step 327, the AP 260, after performing the EAP authentication, delivers a predetermined authentication response message preferably including an IMSI, a MIN, an IP address of the MT 210, and the channel information available for the MT 210 to the WSS/MW 280.

In step 329, the WSS/MGW 280 extracts channel information included in the authentication response message and delivers the extracted channel information to the MSC 240. In step 331, the WSS/MGW 280 transmits an SIP Invite message to the AP 260 to request session connection for WLAN access by the MT 210. In step 333, the MSC 240, which has received the channel information for the handing off MT 210 in step 329, transmits a handoff command message including the received channel information to the MT 210.

In step 335, the MT 210 performs an association (or connection setup) with the AP 260 so that the MT 210 accesses the WLAN. In step 337, the AP 260 transmits an SIP Invite message to the MT 210 using SIP session information that is being maintained after the SIP Invite message was received from the WSS/MGW 280, thereby requesting call setup to the WLAN. In step 339, the MT 210 transmits a 200 OK message to the WSS/MGW 280 in response to the SIP Invite message received in step 331. In step 341, the WSS/MGW 280 transmits an acknowledgement (ACK) message to the MT 210.

In steps 343 and 345, upon receiving the ACK message, the MT 210 releases the connection to the mobile communication network and performs a VoIP voice call with the MSC 240 via the WSS/MGW 280. Herein, the voice traffic transmitted in step 343 is, for example, a voice packet transmitted via the IP network 1, while the voice traffic transmitted in step 345 is, for example, a PCM voice signal. The WSS/MGW 280 converts voice signals from the mobile communication network into voice packets and transmits the voice packets to the WLAN. Further, the WSS/MGW 280 converts voice packets from the WLAN into PCM voice signals and transmits the PCM voice signals to the mobile communication network.

As can be understood from the foregoing description, embodiments of the present invention can provide a seamless handoff service from a mobile communication network supporting a circuit-switched voice service to a WLAN supporting a VoIP service. In addition, embodiments of the present invention can dramatically reduce the WLAN access time of an MT by providing pre-authentication information for the handoff MT to an AP of the WLAN.

Moreover, embodiments of the present invention can provide an SIP-based VoIP service that can be handed off from the mobile communication network, to a subscriber of an office or home network where a WLAN service is provided. Further, embodiments of the present invention can reduce power consumption of the MT by simplifying a handoff process from the mobile communication network to the WLAN.

While the invention has been shown and described with reference to exemplary embodiments thereof, it will be understood by those skilled in the art that various changes in form and details may be made therein without departing from the spirit and scope of the invention as defined by the appended claims.

What is claimed is:

1. A method for providing a handoff between a mobile communication network including a mobile switching center (MSC) for controlling call processing such that a circuit-switched voice service is provided to a mobile terminal (MT), and a home location register (HLR) in which subscriber information is registered, and a wireless local area network (WLAN) including an access point (AP) and a voice over Internet protocol (VoIP) gateway to provide a VoIP service, the method comprising the steps of:
(a) registering, by the AP, subscriber information for the MT comprising an Internet protocol (IP) address of the AP, in the HLR;
(b) transmitting, by the MT, a handoff request to the MSC if the MT connected to the mobile communication network has moved to a region of the WLAN;
(c) transmitting, by the HLR, the subscriber information to the VoIP gateway;
(d) allocating an IP address and a WLAN channel to the MT; and
(e) setting a session for a VoIP service of the MT.

2. The method of claim 1, wherein the subscriber information comprises information regarding the vocoder type of the MT.

3. The method of claim 1, further comprising the step of performing, by the VoIP gateway, subscriber authentication for the MT by transmitting predetermined pre-authentication information for the MT to the AP before channel allocation to the MT.

4. The method of claim 3, wherein the pre-authentication information comprises a medium access control (MAC) address, an international mobile subscriber identity (IMSI), and a mobile identification number (MIN) of the MT.

5. The method of claim 4, wherein the pre-authentication information further comprises a subscriber identity module (SIM).

6. The method of claim 4, wherein the pre-authentication information further comprises a network access identifier (NAI).

7. The method of claim 6, wherein the subscriber authentication for the MT is achieved by the AP by transferring subscriber information with the HLR via an authentication server.

8. The method of claim 7, wherein in step (e), the IP address of the MT is included in a predetermined authentication response message transmitted from the AP to the VoIP gateway based on the subscriber authentication.

9. The method of claim 1, wherein the step (e) comprises the steps of:
allocating, by the AP, an IP address for the MT;
transmitting, by the AP, the channel information to the VoIP gateway;
transmitting, by the VoIP gateway, the channel information to the MSC; and
transmitting, by the MSC, the channel information to the MT.

10. The method of claim 1, wherein the VoIP gateway comprises a wireless soft switch (WSS) for a VoIP service.

11. A system for providing handoff between a mobile communication network supporting a circuit-switched voice service to a mobile terminal (MT) and a wireless local area network (WLAN) supporting a voice over Internet protocol (VoIP)-based voice service, the system comprising:
an access point (AP) for allocating an Internet protocol (IP) address and a wireless channel used by the MT if the MT desires to access the WLAN;
a home location register (HLR) for registering therein predetermined subscriber information for the MT including an IP address of the AP;
a mobile switching center (MSC) for forwarding a handoff request message to the WLAN upon receiving the handoff request message from the MT; and
a switching device for, upon receiving the handoff request message from the MT, receiving the subscriber information from the HLR, performing a predetermined authentication process using the subscriber information, and performing a session connection for WLAN access by the MT.

12. The system of claim 11, wherein the switching device comprises an access gateway (AGW) for delivering the IP address of the AP to the HLR

13. The system of claim 12, wherein the switching device comprises a wireless soft switch (WSS) for receiving the subscriber information from the HLR during the handoff of the MT, and transmitting a request for the session connection to the AP.

14. The system of claim 13, wherein the switching device comprises a media gateway (MGW) for performing data conversion between a voice signal from the mobile communication network and a voice packet from the WLAN.

15. The system of claim 11, wherein the switching device receives channel information for WLAN access by the MT from the AP and delivers the channel information to the MSC;
wherein the MSC is designed such that the MSC delivers the received channel information to the MT.

16. The system of claim 11, wherein the switching device is designed such that upon receiving the subscriber information, the switching device performs the authentication process by transmitting predetermined pre-authentication information for the MT to the AP.

17. The system of claim 16, wherein the pre-authentication information comprises at least one of a medium access control (MAC) address, an international mobile subscriber identity (IMSI), and a mobile identification number (MIN) of the MT.

18. The system of claim 16, wherein the AP performs IP address and channel allocation for the MT after receiving the pre-authentication information for the MT and performing subscriber authentication using the pre-authentication information.

19. A switching device comprised in a wireless location area network (WLAN) that provides a voice over Internet protocol (VoIP) service to at least one mobile terminal (MT), the switching device comprising:
a wireless soft switch (WSS) for registering subscriber information for the MT comprising Internet protocol (IP) information of an access point (AP) for WLAN access by the MT in a home location register (HLR) of a mobile communication network, and upon receiving a handoff request of the MT from a mobile switching center (MSC) of the mobile communication network, performing a session connection for the MT using the subscriber information; and
a media gateway (MGW) connected to the WSS through a gateway control protocol, for performing data conversion between the mobile communication network and the WLAN.

20. The switching device of claim 19, wherein the WSS comprises an HLR interworking block for receiving, from the AP, an IP address registration message including a corresponding IP address and an international mobile subscriber identity (IMSI) and or a mobile identification number (MIN) of the MT, and delivering the received IP address registration message to the HLR.

21. The switching device of claim 19, wherein the WSS comprises a session initiation protocol (SIP) message processor for transmitting a call setup request message to the handoff requesting MT via the AP and receiving a response message from the MT in response to the call setup request message.

22. The switching device of claim 21, wherein the WSS comprises a MGW controller for exchanging a control signal for bearer connection/release with the MGW for call connection/release of the MT.

23. The switching device of claim 19, wherein the WSS is designed such that upon receiving the subscriber information, the WSS transmits predetermined pre-authentication information for the MT to the AP.

24. The switching device of claim 19, wherein WSS receives channel information for WLAN access by the MT from the AP and delivers the channel information to the MSC.
